(19) United States
(12) Patent Application Publication
(10) Pub. No.: US 2003/0004618 A1
(43) Pub. Date: Jan. 2, 2003

(54) Control device for a motor vehicle with a remote control or transponder

(76) Inventor: Andreas Weigl, Linkenheim-Hochstetten (DE)

Correspondence Address: KENYON & KENYON, ONE BROADWAY, NEW YORK, NY, 10004, US

(21) Appl. No.: 09/555,290

(22) PCT Filed: Nov. 25, 1998
(86) PCT No.: PCT/DE98/03464

(30) Foreign Application Priority Data
Nov. 26, 1997 (DE) 197 52 278.5

(51) Int. Cl. G06F 7/00

(52) U.S. Cl. 701/2

(57) ABSTRACT

The invention relates to a control system for a motor vehicle having a remote control unit or transponder for transmitting information to a receiver housed in the motor vehicle, in which the remote control unit or transponder has a battery or a storage cell. The user is continuously informed concerning the charge condition of the battery or storage cell, if it is provided that the remote control unit or transponder has a monitoring unit for the charge condition of the battery or storage cell and that, using a separate control command, a charge condition identifier can be transmitted, which is displayed in the motor vehicle and which, there, identifies the charge condition of the battery or storage cell of the remote control unit or transponder.

### BACKGROUND INFORMATION

The invention relates to a control system for a motor vehicle having a remote control unit or transponder for transmitting information to a receiver housed in the motor vehicle, in which the remote control unit or transponder has a battery or a storage cell.

Control systems of this type are used more and more for alarm systems, vehicle immobilizers, etc., for motor vehicles. As the battery used in the remote control unit or the transponder begins to lose its charge, the transmission range of the transmitter unit in the remote control unit or the transponder contracts. The user of this control system must then approach the receiver in the motor vehicle ever more closely in order to be able to carry out the desired functions via the transmitted control commands. The remote control unit or the transponder can ultimately lose functionality if the battery or the storage cell no longer has sufficient charge.

It is the objective of the present invention to create a control system of the type mentioned above, through which the user is continually informed concerning the charge condition of the battery or storage cell in the remote control unit or transponder.

This objective is achieved according to the present invention through the fact that the remote control unit or transponder has a monitoring unit for the charge condition of the battery or storage cell and that, using a separate control command, a charge condition identifier can be transmitted, which is displayed in the motor vehicle, and which indicates, there, the charge condition of the battery or storage cell of the remote control unit or transponder.

The monitoring unit in the remote control unit or transponder, in response to the transmission of a control command, determines the charge condition of the battery or storage cell and attaches to the control command a charge condition identifier, which the receiver in the motor vehicle evaluates and renders readable for the user as a corresponding display in the motor vehicle.

In the remote control unit or transponder, no charge condition display is necessary. There is no need to provide space for a display, so that the remote control unit or transponder can be designed so as to be smaller and more robust.

In this context, the monitoring unit is only activated upon the transmission of a control command, in order that in the quiescent state, the monitoring unit have no demand for current.

According to one embodiment, the monitoring unit is configured as a limit monitor, which indicates a sufficient charge condition or an insufficient charge condition, transmits to the receiver in the motor vehicle as an assigned charge condition identifier, and displays it.

This monitoring unit is in many cases sufficient. The “good signal” indicates that for the control system a sufficient charge condition of the battery or storage cell in the remote control unit or transponder is present, whereas the “bad signal” refers to the necessity of replacing the battery or of charging the storage cell, but does not assure performance reliability.

The display of the charge condition, in accordance with a further embodiment, can be further varied and graded as a result of the fact that the monitoring unit detects a plurality of charge conditions, transmits them to the receiver in the motor vehicle as corresponding charge condition identifiers, and displays them.

The display in the motor vehicle is preferably implemented in the instrument panel, so that the user can discern it promptly and clearly. In this context, it is advantageous if the display of the charge condition of the battery or storage cell in the remote control unit or transponder is maintained in the motor vehicle for a preselected time period after each transmission of a control command having a charge condition identifier.

1. A control system for a motor vehicle having a remote control unit or transponder for transmitting information to a receiver housed in the motor vehicle, in which the remote control unit or transponder has a battery or a storage cell,
characterized in that the remote control unit or transponder has a monitoring unit for the charge condition of the battery or storage cell and that, using a separate control command, a charge condition identifier can be transmitted, which is displayed in the motor vehicle, and which identifies, there, the charge condition of the battery or storage cell of the remote control unit or transponder.

2. The control system as recited claim 1,
characterized in that the monitoring unit is configured as a limit monitor, which indicates a sufficient charge condition or an insufficient charge condition, transmits to the receiver in the motor vehicle as an assigned charge condition identifier, and displays it.

3. The control system as recited in claim 1,
characterized in that the monitoring unit detects a plurality of charge conditions (e.g., full, 3/4, 1/2, and empty), transmits them to the receiver in the motor vehicle as corresponding charge condition identifiers, and displays them.

4. The control system as recited in one of claims 1 through 3,
characterized in that the display is implemented in the instrument panel of the motor vehicle.

5. The control system as recited in one of claims 1 through 4,
characterized in that the display of the charge condition of the battery or storage cell in the remote control unit or transponder is maintained in the motor vehicle for a predetermined time period after each transmission of a control command having a charge condition identifier.

6. The control system as recited in one of claims 1 through 5,
characterized in that the monitoring unit can be activated only in response to the transmission of a control command.
